(19) United States
(12) Patent Application Publication
(10) Pub. No.: US 2015/0091265 A1
(43) Pub. Date: Apr. 2, 2015

(54) Garden utility cart

(71) Applicant: Coleen Bentson, Valrico, FL (US)

(72) Inventor: Coleen Bentson, Valrico, FL (US)

(21) Appl. No.: 14/504,150

(22) Filed: Oct. 1, 2014

Related U.S. Application Data
(60) Provisional application No. 61/885,249, filed on Oct. 1, 2013.

(51) Int. Cl. B62B 1/10; B62B 1/00; B62B 1/26

(52) U.S. Cl. CPC B62B 1/10; B62B 1/26; B62B 1/008
USPC 280/47.19

(57) ABSTRACT

A garden utility cart suitable for carrying leaves and different types of tools efficiently is box-shaped and sized to hold a standard thirty gallon garbage bag, with a large elastic band around the rim to secure it into place. The cart is used to carry garden waste, leaves, or tools with long handles; such as a shovel, a rake, and a broom. Pockets on the sides of the cart are sized for smaller tools, a water bottle, a can of insect repellent, or a cellular telephone. A rear pocket below the handle, contains a kneeling pad. Wheels on the rear corners and a front peg at the center of the lower leading edge provide a tripod mount. A net for the top opening may be affixed with the elastic band, to secure leaves and other garden waste.

### CROSS-REFERENCE TO RELATED APPLICATIONS

This application claims the benefit of U.S. Provisional Application No. 61/885249, filed Oct. 1, 2013, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to lawn and garden tools and accessories and in particular to a garden utility cart. Previously hand carts have been designed for use in a garden, but each has been unsatisfactory for various reasons. A garden utility cart that is designed for multiple purposes, to carry leaves or several different types of tools efficiently, would provide what previous designs are lacking.

### SUMMARY OF THE INVENTION

Accordingly, the invention is directed to a garden utility cart that is designed for multiple purposes, to carry leaves or several different types of tools efficiently. The cart body is box-shaped and sized to hold a standard thirty gallon garbage bag, with a large, thick elastic band around the rim to secure the garbage bag in place. When not hauling leaves or other garden waste, the cart may be used to carry tools with long handles, such as a shovel, a rake, and a broom. Side pockets on the sides of the cart are sized for smaller tools, such as garden shears, as well as a water bottle, a can of insect repellent, and a cellular telephone. A rear pocket on the rear surface, below the handle, contains a kneeling pad. Wheels on the rear corners and a front peg at the center of the lower leading edge provide a sturdy tripod mount. An optional net 40 for the top opening may be affixed with the elastic band, to secure leaves and other garden waste that is easily spilled, or blown away by the wind. The cart is easily cleaned with a garden hose and used for additional purposes, such as bringing in harvested vegetables from the garden.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 shows a side view of the first exemplary embodiment, displaying the body 10, the elastic band 11, the side pockets 12, the wheels 13, the front peg 14, the handle 15, the front finger groove 16, the rear face 100, the front face 101, the top face 102, the side faces 103, and the bottom face 104.

FIG. 2 shows a rear view of the first exemplary embodiment, displaying the body 10, the wheels 13, the front peg 14, the handle 15, the rear pocket 17, the rear pocket flap 18, and the kneeling pad 19.

FIG. 3 shows an elevated side view of an alternative representation of the first exemplary embodiment, displaying the body 10, the elastic band 11, the pockets 12, the handle 15, and the rear pocket 17.

FIG. 4 shows a perspective view of a portion of the alternative representation of the first exemplary embodiment, displaying the body 10, the handle 15, the rear pocket 17, and the fitted net 40.

FIG. 5 shows a scene of the first exemplary embodiment in use.

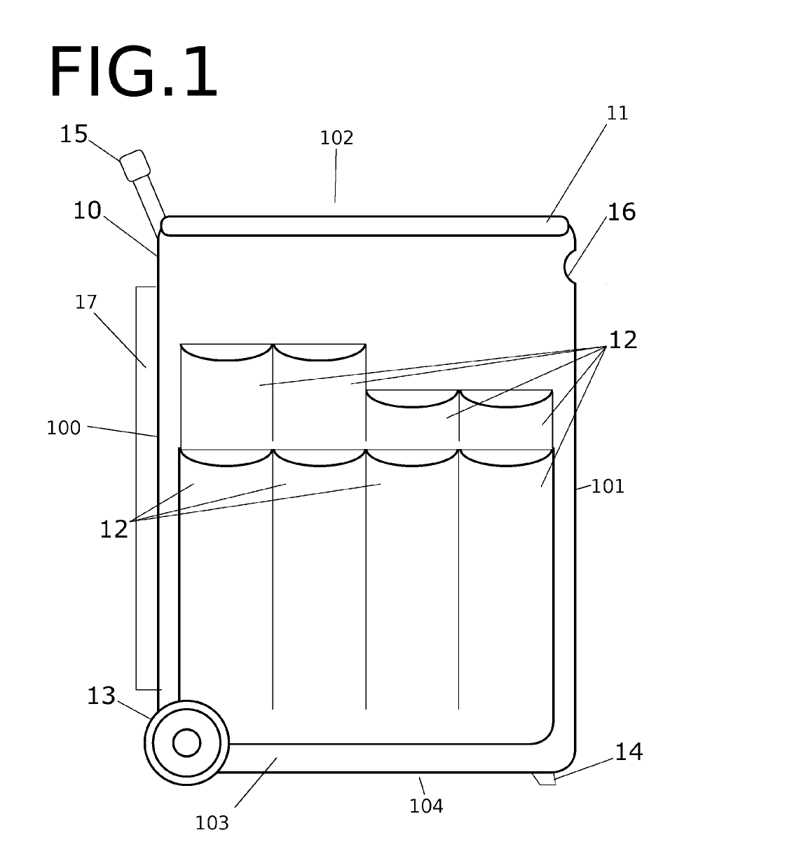

### DETAILED DESCRIPTION OF THE INVENTION

Referring now to the invention in more detail, the invention is directed to a garden utility cart that is designed for multiple purposes, to carry leaves or several different types of tools efficiently. The cart body 10 is box-shaped, open-topped, and such that its top perimeter is sized to retain a standard thirty gallon garbage bag, and the interior volume is complementary to the thirty gallon garbage bag in size. A large, thick elastic band 11 is placed around the rim to secure the garbage bag in place. When not hauling leaves or other garden waste, the cart may be used to carry tools with long handles, such as a shovel, a rake, and a broom. The cart is easily cleaned with a garden hose and used for additional purposes, such as bringing in harvested vegetables from the garden.

Preferably, the cart body 10 is twenty inches long, fourteen inches wide, and twenty-four inches tall. The body 10 is sized to contain a thirty gallon garbage bag that is filled to capacity. Interior surfaces of the body 10 are smooth, and the corners and edges of the body 10 are rounded, to ease cleaning of the interior and enable the user to remove the garbage bag without ripping it. The color of the body 10 is preferably brown or green.

Side pockets 12 on each of the pair side faces 103 of the cart are sized for smaller tools, such as garden shears, as well as a water bottle, insect repellent, and a cellular telephone. Preferably, there are four side pockets 12 on each side: two of the side pockets on each side feature apertures to slide in tools, and the other two side pockets 12 on each side are deeper to hold personal items. More or fewer side pockets are also contemplated.

The handle 15 is rigid and does not fold or telescope because it is intended for pulling rather than pushing. A rear pocket 17 affixed to the rear face 100, below the handle 15, contains a kneeling pad 19. Wheels 13 with flexible tires on the rear corners at the base of the rear face 100, and a front peg 14 at the center of the lower leading edge, provide a sturdy tripod mount. An optional fitted net 40 for the top opening may be affixed with the elastic band 11, to secure leaves and other garden waste that is easily spilled, or blown away by the wind.

A front finger groove 16, located on the outer surface of the body 10 and is concave inward, is provided across the entire width of the body 10, near the upper rim. The cart may be easily lifted by grasping the handle 15 with one hand and grasping the front finger groove 16 with the fingers of the other hand. Side finger grooves are also provided on both side surfaces, along the entire length of the cart 10, near the upper rim. The side finger grooves are also located on the outer surface of the body 10 and are concave inward. The cart may be easily lifted by grasping a side finger groove with the fingers of one hand and grasping the opposite side finger groove with the fingers of the other hand.

Alternate embodiments, featuring side pockets 12 and a rear pocket 17 which are mounted on a removable fabric skirt, are contemplated. In the alternate embodiments, the removable skirt covers the rear face 100 and side surfaces of the body 10 and is affixed to the body 10 with metal snaps, hook-and-loop fastener strips, or other similar fasteners.

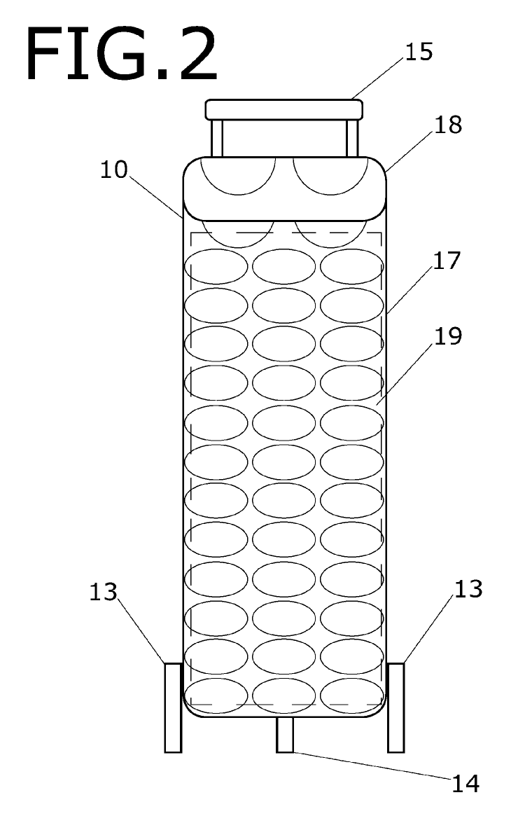

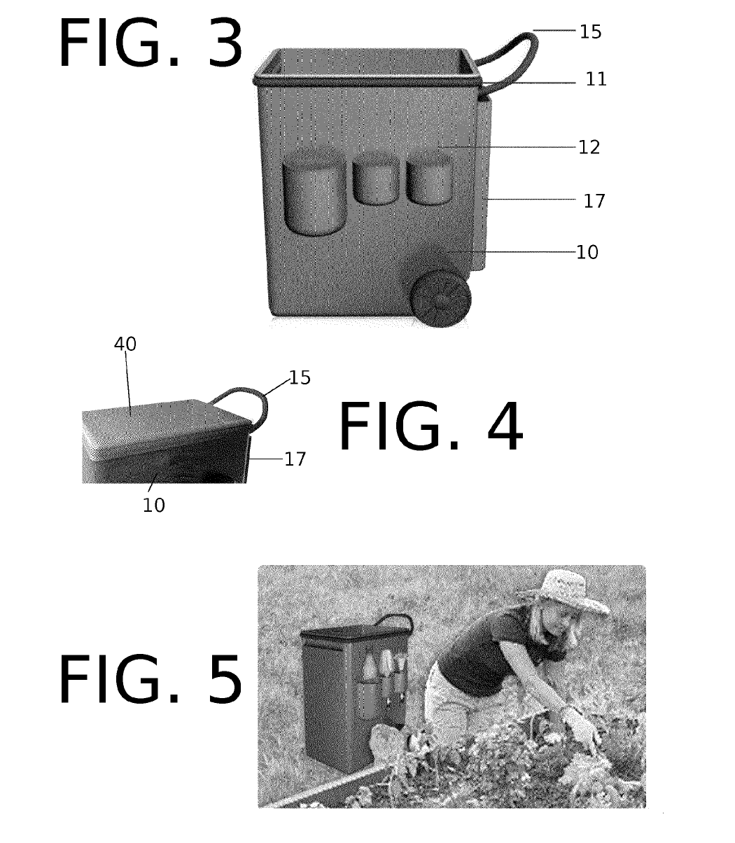

In the first exemplary embodiment, the rear pocket 17 is preferably manufactured from a flexible, durable mesh material, such as nylon mesh, and preferably features a rear pocket flap 18 along the upper edge for closure, which is preferably manufactured from a solid, flexible fabric, such as nylon or cotton twill. The nylon mesh construction enables the kneeling pad 19 to dry out while stored in the rear pocket 17, and also enables the user to see from a distance whether the kneeling pad 17 has been stored in the rear pocket 17. The circular patter shown in FIG. 2 represents the breathable and see-through mesh of the rear pocket 17. Alternate embodiments, wherein the rear pocket 17 is manufactured from a solid, flexible fabric such as cotton twill, or from the same rigid material as the body 10, are also contemplated.

Metal snaps, hook-and-loop fastener strips, or other similar fasteners are used to secure the rear pocket 17 and rear pocket flap 18 to the body 10, and also to secure the lower edge of the rear pocket flap 18 to the rear pocket 17. In alternate embodiments, wherein the side pockets 12 and rear pocket 17 are mounted on a removable fabric skirt, the side pockets 12 are secured to the removable skirt with triple stitching. The rear pocket 17 and rear pocket flap 18 may be secured to the removable skirt with triple stitching, or they may be may be secured with metal snaps, hook-and-loop fastener strips, or other similar fasteners.

The kneeling pad 19 is preferably manufactured from a flexible, durable material such as foam rubber, and features ergonomic bumps on its surface to enable the user to kneel on it for extended periods of time.

To use the first exemplary embodiment to gather leaves and other garden waste, the user inserts a thirty gallon garbage bag into the body 10, such that the upper edge of the garbage bag extends a few inches above the upper rim of the body 10. The user folds the edge of the garbage bag down over the upper rim of the body 10, and secures the edge of the garbage bag to the upper rim of the body 10, using the elastic band 11. The user then pulls the cart into the garden using the handle 15, and proceeds with gathering leaves and placing them in the garbage bag.

To use the first exemplary embodiment to carry tools and other items, the user places long-handled tools, such as a rake or a shovel, into the body 10. Such long-handled tools would generally be carried with the handles pointed downward. The user may place shorter tools, such as garden shears, in the side pockets 12. A water bottle or other beverage container, a can of insect repellent, and a cellular telephone may also be placed in side pockets 12 which are sized for these items. The user then grasps the handle 15 and pulls the cart into the garden.

In the first exemplary embodiment, the body 10, side pockets 12, and front peg 14 are preferably manufactured from rigid, durable materials which are easily cleaned, such as high-impact plastic, steel, and aluminum. The elastic band 11 is preferably manufactured from a flexible, durable material with high elasticity, such as rubber or elasticized cotton. The wheels 13 are preferably manufactured from a rigid, durable material such as high-impact plastic, steel, or aluminum, featuring solid tires which are preferably manufactured from a flexible, durable material such as rubber or silicone. The handle 15 is preferably manufactured from a rigid, durable material such as steel, aluminum, or wood, featuring a handgrip cover which is preferably manufactured from a flexible, durable material such as foam rubber or silicone.

The rear pocket 17 and the optional fitted net 40 preferably manufactured from a flexible, durable mesh material, such as nylon mesh. The rear pocket flap 18 is preferably manufactured from a flexible, durable fabric such as nylon, cotton twill, a cotton-rayon blend, or a cotton-polyester blend. Snaps and other rigid fasteners are preferably manufactured from rigid durable materials such as steel, aluminum, or brass. Hook-and-loop fastener strips and other flexible fasteners are preferably manufactured from flexible, durable materials such as nylon or plastic. The kneeling pad 19 is preferably manufactured from a flexible, durable material such as foam rubber, featuring a removable cover which is preferably manufactured from a flexible, durable fabric which is easily cleaned such as cotton or nylon.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A garden utility cart comprising a cart body; said cart body being box shaped; said cart body having a rear face, a front face, a pair of side faces, a top face, and a bottom face; said cart body being box shaped, open-topped, and of a size complementary to standard garbage bags; an elastic band; said elastic band being fitted around said front face, said rear face, and said pair of side faces at the top of said cart body; said elastic band being configured to as to secure standard garbage bags; a plurality of side pockets; said plurality of side pockets being affixed to one or more of said side faces; a pair of wheels; said pair of wheels being rotatably affixed to the bottom rear of said cart body; a front peg; said from peg being affixed to the bottom front of said cart body; a handle; said handle being affixed to the top rear of said cart body; a finger groove; said finger groove comprising a grippable shape in one or more of the group of said front face, said rear face, or said pair of side faces.

2. The garden utility cart of claim 1 further comprising a fitted net; said fitted net being sized to fit over said top face; and said fitted net been removably affixed to said card body by said elastic band.

3. The garden utility cart of claim 1 wherein said side pockets are of rigid material.

4. The garden utility cart of claim 1 wherein said side pockets comprise a fabric skirt;
said fabric skirt being removably affixed to the exterior of said cart body.

5. The garden utility cart of claim 2 wherein said side pockets are of rigid material.

6. The garden utility cart of claim 2 wherein said side pockets comprise a fabric skirt;
said fabric skirt being removably affixed to the exterior of said cart body.

7. The garden utility card of claim 1 further comprising a rear pocket; a kneeling pad;
said rear pocket being sized sufficiently to removably contain said kneeling pad;
said rear pocket being made of a breathable and see-though mesh; and said rear pocket being affixed to said rear face.

8. The garden utility card of claim 2 further comprising a rear pocket; a kneeling pad;
said rear pocket being sized sufficiently to removably contain said kneeling pad;
said rear pocket being made of a breathable and see-though mesh; and said rear pocket being affixed to said rear face.

9. The garden utility card of claim 3 further comprising a rear pocket; a kneeling pad;
said rear pocket being sized sufficiently to removably contain said kneeling pad;
said rear pocket being made of a breathable and see-though mesh; and said rear pocket being affixed to said rear face.

10. The garden utility card of claim 4 further comprising a rear pocket; a kneeling pad;
said rear pocket being sized sufficiently to removably contain said kneeling pad;
said rear pocket being made of a breathable and see-though mesh; and said rear pocket being affixed to said rear face.

11. The garden utility card of claim 5 further comprising a rear pocket; a kneeling pad;
said rear pocket being sized sufficiently to removably contain said kneeling pad;
said rear pocket being made of a breathable and see-though mesh; and said rear pocket being affixed to said rear face.

12. The garden utility card of claim 6 further comprising a rear pocket; a kneeling pad;
said rear pocket being sized sufficiently to removably contain said kneeling pad;
said rear pocket being made of a breathable and see-though mesh; and said rear pocket being affixed to said rear face.
